(19) United States
(12) Patent Application Publication
(10) Pub. No.: US 2018/0171696 A1
(43) Pub. Date: Jun. 21, 2018

(54) DOOR OPENING AND CLOSING DEVICE

(71) Applicant: TOSHIBA TEC KABUSHIKI KAISHA, Tokyo (JP)

(72) Inventor: Wataru SAKURAI, lzu Shizuoka (JP)

(21) Appl. No.: 15/841,510

(22) Filed: Dec. 14, 2017

(30) Foreign Application Priority Data
Dec. 16, 2016 (JP) 2016-244372

(51) Int. Cl. E05F 15/40; E05F 15/60

(52) U.S. Cl. CPC E05F 15/40; E05F 15/60; G06K 7/10415; E05Y 2400/445; E05Y 2400/20

(57) ABSTRACT

An opening and closing load device includes a door configured to be openable and closable with respect to an opening in a side of a housing, the housing including a perimeter wall surrounding the opening, a seal member provided on a perimeter of the door or the perimeter wall and configured to seal the opening when the door is closed to sandwich the seal member between the door and the perimeter wall, and a controller configured to adjust an attraction force between the door and the perimeter wall based on a distance between the door and the perimeter wall.

### CROSS-REFERENCE TO RELATED APPLICATION

This application is based upon and claims the benefit of priority from Japanese Patent Application No. 2016-244372, filed Dec. 16, 2016, the entire contents of which are incorporated herein by reference.

### FIELD

Embodiments described herein relate generally to a door opening and closing device.

### BACKGROUND

In the related art, a gasket is provided in a refrigerator as an elastic member to bring a door portion and a refrigerator main body into close contact with each other in order to prevent cold air inside the refrigerator from leaking out to the outside. The gasket is made of an elastic member and a magnet is inserted inside the gasket. Sealing between the door portion and the refrigerator main body is maintained without a gap by the magnet attracting a metal portion of the refrigerator main body when the door of the refrigerator is closed.

However, the gasket made of the elastic member becomes thinner when the door is kept closed as a result of the pressing force on the gasket. On the other hand, the compressed gasket returns to its original thickness when the door is kept open. In this manner, the force necessary when opening and closing the door changes as the thickness of the gasket changes. For this reason, a problem, in which the door is difficult to open or the door is difficult to close, might occur.

### DESCRIPTION OF THE DRAWINGS

FIG. 1 is an external perspective view illustrating a configuration of a document reading apparatus according to a first embodiment.

FIGS. 2A and 2B are external perspective views illustrating a schematic configuration of a reading unit. FIG. 2A is an external perspective view illustrating a state where a door is opened. FIG. 2B is an external perspective view illustrating a state where the door is closed.

FIG. 3 illustrates a schematic configuration of an open and closed state detecting mechanism.

FIGS. 4A and 4B illustrate schematic structures of a housing and the door. FIG. 4A is a top view of the housing seen from a positive side of the Z-axis. FIG. 4B is a front view of the housing seen from a negative side of the Y-axis.

FIG. 5 is a graph showing an example of a relationship between an estimated thickness of a gasket and the magnitude of a current flowing in an electromagnet.

FIG. 6 is a block diagram showing hardware configurations of a main body unit and the reading unit.

FIG. 7 is a block diagram showing functional configurations of the main body unit and the reading unit.

FIG. 8 is a flow chart showing an operation example of the main body unit and the reading unit.

FIG. 9 is a top view of a reading unit in a document reading apparatus according to a second embodiment.

FIG. 10 is a flow chart showing an operation example of a main body unit and the reading unit.

FIGS. 11A and 11B illustrate a configuration of a reading unit in a document reading apparatus according to a third embodiment. FIG. 11A is a top view of a reading unit. FIG. 11B is a rear view of a door.

FIGS. 12A and 12B illustrate a principle for a capacitive sensor to estimate a distance between the door and an area of the housing around an opening. FIG. 12A illustrates an example of a state of the capacitive sensor when the door is separated away from the area of the housing around the opening. FIG. 12B illustrates an example of a state of the capacitive sensor when the door and the area of the housing around the opening are close to each other.

FIGS. 13A and 13B illustrate a configuration of a reading unit in a document reading apparatus according to a fourth embodiment. FIG. 13A is a top view of a reading unit. FIG. 13B illustrates a measuring principle for an open and closed state detecting unit.

### DETAILED DESCRIPTION

Embodiments provide a door opening and closing device that can adjust an opening and closing load of a door of an accommodating container.

The door opening and closing device of the embodiment includes a door configured to be openable and closable with respect to an opening in a side of a housing, the housing including a perimeter wall surrounding the opening, a seal member provided on a perimeter of the door or the perimeter wall and configured to seal the opening when the door is closed to sandwich the seal member between the door and the perimeter wall, and a controller configured to adjust an attraction force between the door and the perimeter wall based on a distance between the door and the perimeter wall.

### First Embodiment

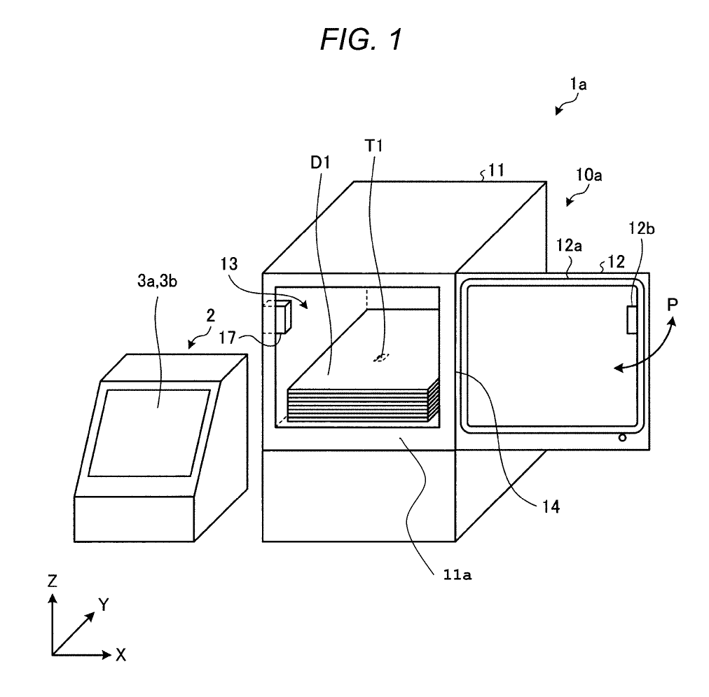

A document reading apparatus, which is an example of a door opening and closing device, will be described with reference to the drawings. FIG. 1 is an external perspective view illustrating a configuration of a document reading apparatus 1a according to a first embodiment. The document reading apparatus 1a reads radio frequency identification (RFID) tags T1 attached to documents D1 such as a slip, an admission ticket, a book, a license, and a passport. The document reading apparatus 1a is provided and used, for example, on a desk. FIG. 1 illustrates a state where a door 12, which is included in a reading unit 10a is in the open position.

As illustrated in FIG. 1, the document reading apparatus 1a includes a main body unit 2 and the reading unit 10a. The reading unit 10a includes the door opening and closing device. The main body unit 2 includes a display 3b on a surface of which a touch panel 3a is provided. For example, a liquid crystal display is used as the display 3b.

The reading unit 10a is an RFID reading and writing device that can read information from the RFID tags T1 attached to the documents D1 and can write information in the RFID tags T1. In the first embodiment, each RFID tag T1 stores information such as a document code to identify the document to which it is attached.

The reading unit 10a is connected to the main body unit 2 by means of a cable (not illustrated). The reading unit 10a outputs (transmits) various types of information such as document codes read from the RFID tags T1 to the main body unit 2 in a wired or a wireless manner. Although the main body unit 2 and the reading unit 10a are separate members in the first embodiment, the main body unit and the reading unit are not limited thereto and may be integrally configured.

In addition, the reading unit 10a has a housing 11, which configures the main exterior of the reading unit 10a, and the door 12 (an example of a door portion), which is openable and closable with respect to an opening 13 into the interior of the housing 11 forming an accommodating chamber 19. The housing 11 is box shaped, and has a depth (length in the Y-direction) which is larger than a horizontal width (length in the X-direction). The housing 11 may be integrated with the main body unit 2, or may be configured so as to be detachable from the main body unit 2. The door 12 is linked to the housing 11 by hinge portions 14 provided on a right front surface of the housing 11, and opens and closes by pivoting around the hinge portions 14 in the direction of arrow P.

A gasket 12a is an example of a seal member and is described below. The gasket 12a is an elastic member that fills a space or gap otherwise present between the housing 11 and the door 12 when the door 12 is closed to maintain the opening 13 in a sealed state. The gasket 12a is provided on the door around its perimeter at a back surface of the door 12 and faces the accommodating chamber 19 when the door is in the closed position. The gasket 12a is configured of, for example, a rubber member, and comes into contact with a perimeter wall 11a of the housing 11 surrounding the opening 13 when the door 12 is closed. In this state, since the gasket 12a receives the reaction force of the force maintaining the door 12 in the closed state from the opening 13, the gasket maintains a state of staying in close contact with the perimeter wall 11a of the housing 11 surrounding the opening 13. Accordingly, the opening 13 is maintained in a sealed state when the door 12 is closed. Alternatively, the gasket 12a may be provided on the perimeter wall 11a surrounding the opening 13.

As illustrated in FIG. 1, a plate 12b (an example of a metal body), which is thinner than the gasket 12a, is provided on an inner peripheral side of the gasket 12a. The plate 12b may be made of an iron based material but is not limited thereto, so long as it is magnetically attractable. The plate 12b is provided at a position opposing an electromagnet 17 when the door 12 is closed. The electromagnet 17 is operated by causing a current to flow in the electromagnet 17 when closing the door 12. Then, the door 12 is drawn toward the housing 11 since the plate 12b is pulled toward the electromagnet 17. In this state, since the plate 12b is thinner than the gasket 12a, the gasket 12a is pressed against the perimeter wall 11a of the housing 11 surrounding the opening 13 when the plate 12b is pulled toward the electromagnet 17. Accordingly, the door 12 and the perimeter wall 11a of the housing 11 surrounding the opening 13 can maintain a state of staying in close contact with each other without a the presence of a gap between them and opposed sides of the gasket 12a.

A storage region for writing a registration completion flag is reserved in each RFID tag T1 (to be described later). The presence and absence of a registration completion flag is checked, for example, at a gate provided at an entrance of a building or and office on which the document reading apparatus 1a is provided. When there is no registration completion flag, a warning is issued by an informing unit such as a buzzer.

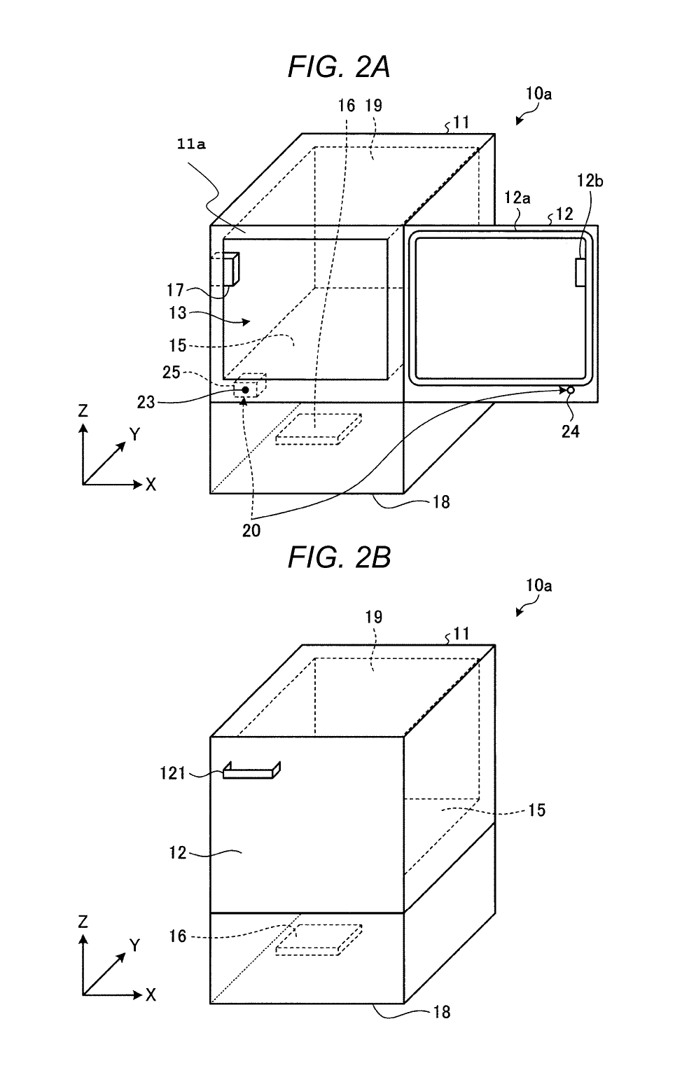

Hereinafter, the reading unit 10a will be described. FIGS. 2A and 2B are external perspective views illustrating a schematic configuration of the reading unit 10a. FIG. 2A illustrates a state where the door 12 of the reading unit 10a is opened. FIG. 2B illustrates a state where the door 12 of the reading unit 10a is closed.

A handle 121 is mounted on the door 12 to open and close access to the opening 13. An operator grasps the handle 121 to open and close the door 12.

The opening 13 has a size that allows a plurality of documents D1 to be passed thereinto simultaneously. The opening 13 in the housing 11 opens into the accommodating chamber 19 that has a size which allows the plurality of documents D1 to be accommodated inside thereof. An operator can place the documents D1 inside the accommodating chamber 19 and take out the documents D1 from the accommodating chamber 19 through the opening 13 of the housing 11 by opening the door 12. The documents D1 may be located in the accommodating chamber 19 in a container made of an insulating (radio wave permeable) member made of a material such as wood and glass.

In the accommodating chamber 19, the documents D1 are placed onto a placing surface 15, which is a bottom surface of the accommodating chamber 19. The placing surface 15 is configured of an insulating (radio wave permeable) plate shaped member made of a material such as wood and glass, and is supported with a predetermined gap between a bottom surface 18 of the housing 11 and the placing surface. Inner wall surfaces in the accommodating chamber 19 of the housing 11, except for the placing surface 15 are made of a material which reflects radio waves (radio wave reflecting material) including the wall surface of the door 12 on the accommodating chamber 19 side thereof. An example of radio wave reflecting materials include a molding material and ferrite.

A planar RFID antenna 16 and a circuit board (not illustrated) are provided in a space between the placing surface 15 and the bottom surface 18 of the housing 11. The RFID antenna 16 communicates with the RFID tag T1 existing in the accommodating chamber 19 by emitting radio waves in the UHF band, that is, the RFID tag T1 attached to each document D1 accommodated in the accommodating chamber 19. In addition, the RFID antenna 16 emits radio waves when the door 12 is closed by cooperating with an RFID reading and writing unit 41 to be described later.

Outer wall surfaces of the housing 11 and the door 12 are made of a radio wave reflecting material or a radio wave absorbing material in order to prevent radio waves in the housing 11 from being released to the outside and to prevent external radio waves from intruding into the housing 11. Examples of radio wave reflecting materials are a molding material and ferrite. Alternately, radio wave absorbing materials can be used for such a member.

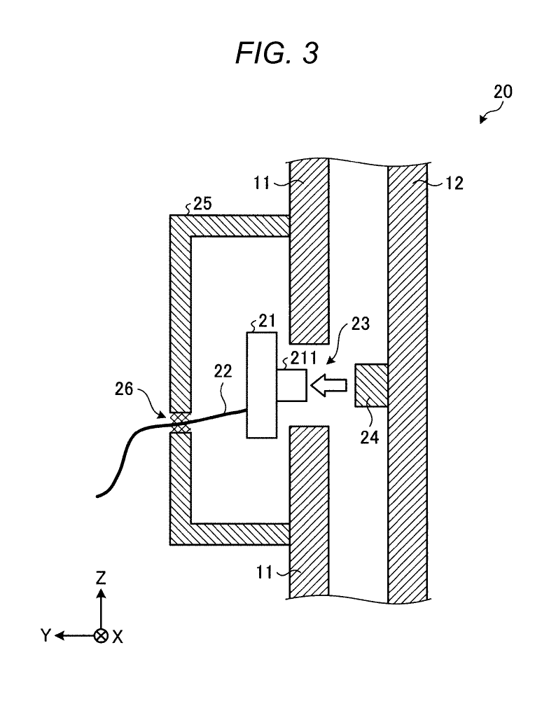

An open and closed state detecting mechanism 20 for detecting the open and closed states of the door 12 is provided in a portion on the housing 11 side, which is in contact with or is close to the door 12 when the door 12 is in the closed state. A first portion of the open and closed state detecting mechanism 20 is provided on the inner portion of the perimeter wall 11a of the housing 11 which surrounds the opening 13, and at least a portion of the first portion is in contact with or is close to the door 12 when the door 12 is in the closed state, and a second portion of the open and closed state detecting mechanism 20 is provided on the door 12 opposing the perimeter wall 11a of the housing 11 surrounding the opening 13. Hereinafter, a configuration of the open and closed state detecting mechanism 20 will be described with reference to FIG. 2A and FIG. 3.

(Description of the Open and Closed State Detecting Mechanism for Door)

FIG. 3 illustrates a schematic configuration of the open and closed state detecting mechanism 20. FIG. 3 is a partial sectional view of the open and closed state detecting mechanism 20 seen from a negative side of the X-axis illustrated in FIG. 2A. The open and closed state detecting mechanism 20 has, for example, a switch 21, which includes a mechanical switch performing turning-on operation only when the switch is pressed, such as a push switch or a tactile switch, inside a cover portion 25 provided on an inner wall of the housing 11. A first hole 23 having a size corresponding to a push portion 211 of the switch 21 is provided on the housing 11 side at a position opposing the switch 21, i.e., through the perimeter wall 11a surrounding the opening 13.

On a wall surface of the door 12 on the housing facing side thereof, a projecting portion 24 is formed at a position opposing the first hole 23 (and switch 21) of the housing 11 when the door 12 is in the closed state. The projecting portion 24 has a smaller diameter than the diameter of the first hole 23. The projecting portion 24 can operate the switch 21 by pressing on the push portion 211 of the switch 21 when the door 12 is in the closed state.

When the door 12 comes into a state of being about to be closed and the door 12 approaches the opening 13, the projecting portion 24 of the door 12 presses the push portion 211 through the first hole 23 and the switch 21 is turned on since the open and closed state detecting mechanism. 20 has the configuration described above. In addition, when the door 12 comes into a state of being about to be opened, the projecting portion 24 of the door 12 releases the pressing of the push portion 211 and the switch 21 is turned off. The switch 21 detects whether the door 12 is in a state of being about to be closed or is in a state of being about to be opened based on switching between on and off by the projecting portion 24. The switch 21 outputs a signal indicating that the door 12 is in a state of being about to be closed to the main body unit 2 and the reading unit 10a via a wire harness 22 under a condition that the switch is turned on from being turned off. In addition, the switch 21 outputs a signal indicating that the door 12 is in a state of being about to be opened to the main body unit 2 and the reading unit 10a via the wire harness 22 under a condition that the switch is turned off from being turned on.

In the configuration described above, there is a possibility that radio waves from the RFID antenna 16 are released to the outside of the housing 11 through the first hole 23 of the housing 11. In addition, there is a possibility that radio waves outside the housing 11 intrude into the housing 11 through the first hole 23 of the housing 11. Such release and intrusion of radio waves are causes of the misreading and malfunctioning of the RFID tag T1 in this and other reading devices.

Therefore, the open and closed state detecting mechanism 20 includes a blocking unit that blocks radio waves released to the outside from the housing 11 and radio waves intruding from the outside into the housing 11, at a portion where the switch 21 is provided.

Specifically, the open and closed state detecting mechanism 20 includes the aforementioned cover portion 25 as the blocking unit, which covers the periphery of the switch 21 and the first hole 23. The cover portion 25 is made of a radio wave reflecting material or a radio wave absorbing material, and is connected to the inner wall of the housing 11 without a gap therebetween by screw-fixing or welding.

A second hole 26 through which the wire harness 22 passes is provided in the cover portion 25. Herein, the size of the second hole 26 is not particularly limited and, for example, may correspond to the diameter of the wire harness 22. It is preferable that a gap between the wire harness 22 and the second hole 26 be filled with a conductive material having radio wave (electromagnetism) shielding properties. A metal mesh and metal foam can be used as such a conductive material. As a consequence, radio waves can be prevented from being released or intruding through the second hole 26.

(Description of the Opening and Closing Mechanism for Door)

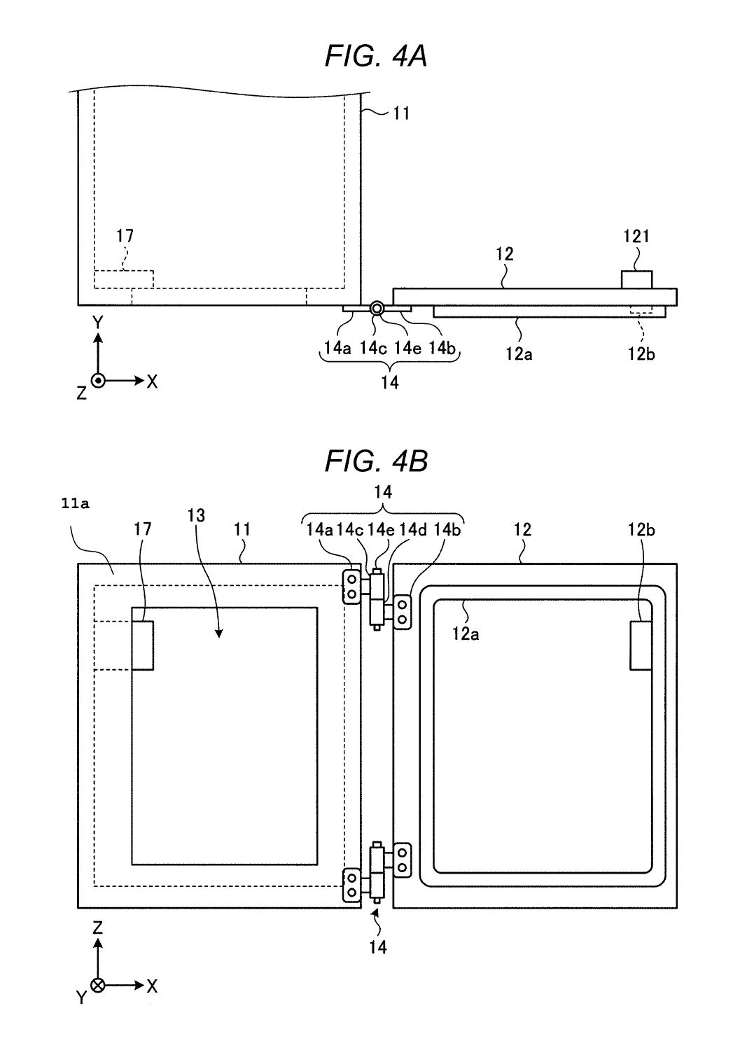

Next, an opening and closing mechanism for the door 12 will be described with reference to FIG. 4. FIGS. 4A and 4B illustrate schematic structures of the housing 11 and the door 12. FIG. 4A is a top view of the housing 11 seen from a positive side of the Z-axis. FIG. 4B is a front view of the housing 11 seen from a negative side of the Y-axis.

The hinge portions 14 are configured as, for example, flat hinges. The hinge portions 14 each include a fixed side hinge piece 14a, a movable side hinge piece 14b, a fixed side shaft cylinder 14c, a movable side shaft cylinder 14d, and a shaft portion 14e. The fixed side hinge pieces 14a are mounted on the housing 11. The movable side hinge pieces 14b are mounted on the door 12. The fixed side shaft cylinders 14c each are integrated with the fixed side hinge piece 14a, and are fixed to the movable side shaft cylinder 14d to be described later so as to be openable and closable with the shaft portion 14e as an axis. The movable side shaft cylinders 14d each are integrated with the movable side hinge piece 14b, and are fixed to the aforementioned fixed side shaft cylinder 14c so as to be openable and closable with the shaft portion 14e as an axis. As illustrated in FIG. 4B, the hinge portions 14 are mounted on upper and lower ends of the door 12, respectively.

Once a current is caused to flow in the electromagnet 17 when the door 12 is close to the vicinity of the perimeter wall 11a of the housing 11 surrounding the opening 13, the plate 12b is pulled toward the electromagnet 17. Since the plate 12b is connected to the door 12, the door 12 is pulled toward the housing 11, and an operator of the door 12 can reliably close the door 12 with a small load without applying unnecessary force. Timing at which a current is caused to flow in the electromagnet 17 may be determined as appropriate. For example, as described above, when the door 12 comes into a state of being about to be closed and it is detected that the push portion 211 of the switch 21 is being pressed by the projecting portion 24 of the door 12, a current may be caused to flow in the electromagnet 17. That is, a current is caused to flow in the electromagnet 17 under a condition that a distance between the door 12 and the perimeter wall 11a of the housing 11 surrounding the opening 13 is estimated and the distance is less than a threshold distance.

In addition, the force attracting the door 12 to the housing 11 is discontinued by stopping the current flowing in the electromagnet 17 when opening the door 12. Thus, an operator can open the door 12 by pulling the handle 121 with a small force. Although the timing at which the current flowing in the electromagnet 17 is stopped may be determined as appropriate, a current flowing in the electromagnet 17 may be stopped, for example, when the door 12 comes into a state of being about to be opened and it is detected that the projecting portion 24 of the door 12 is separated away from the push portion 211 of the switch 21 as described above. That is, a current flowing in the electromagnet 17 may be stopped under a condition that the estimated distance between the door 12 and the perimeter wall 11a of the housing 11 surrounding the opening 13 is equal to or larger than the threshold distance.

(Description of Method for Controlling Opening and Closing Load of the Door)

The thickness of the gasket 12a provided on the door 12 changes as described above. For example, when the door 12 is left in the closed state, the gasket 12a becomes thinner. When the door 12 is closed in a state where the gasket 12a is thin, a distance between the electromagnet 17 and the plate 12b when the gasket 12a is in contact with perimeter wall 11a of the housing 11 surrounding the opening 13 is smaller compared to a case where the gasket 12a is thick (i.e., when the door 12 is an open state). Since the plate 12b (door 12) is pulled toward the electromagnet 17 with stronger attraction force, the door 12 is suddenly drawn toward the housing 11.

On the other hand, when the door 12 is left in the open state, the thickness of the gasket 12a which had become thinner returns to its original thickness. When the door 12 is closed in a state where the gasket 12a is thick, the distance between the electromagnet 17 and the plate 12b when the gasket 12a is in contact with the perimeter wall 11a of the housing surrounding the opening 13 becomes larger compared to a case where the gasket 12a is thin (i.e., when the door 12 is in a closed state). Accordingly, the force of the electromagnet 17 attracting the plate 12b (door 12) becomes smaller. For this reason, the door 12 is barely drawn toward the housing 11. Thus, it is necessary for an operator to increase the load to close the door 12.

The document reading apparatus 1a changes the magnitude of a current flowing in the electromagnet 17 according to the thickness of the gasket 12a, and thereby controls the opening and closing load of the door 12 within a desired range. As a consequence, an operator can open and close the door 12 with a constant opening and closing load regardless of a change in the thickness of the gasket 12a. That is, when closing the door 12 in a state where the gasket 12a is thin, a current flowing in the electromagnet 17 is decreased and the amount of operating force exerted to assist in closing the door 12 is decreased. On the other hand, when closing the door 12 in a state where the gasket 12a is thick, a current flowing in the electromagnet 17 is increased, and the amount of operating force exerted to assist in closing the door 12 is increased.

In the embodiment, the document reading apparatus 1a measures the cumulative time during which the door 12 is left in the open state, that is, cumulative open time Q1 instead of measuring the thickness of the gasket 12a. Likewise the document reading apparatus 1a measures the cumulative time during which the door 12 is left in the closed state, that is, cumulative closed time Q2. The document reading apparatus 1a estimates the thickness of the gasket 12a based on the cumulative open time Q1 and the cumulative closed time Q2. When the door 12 is in the closed state, the cumulative closed time Q2 is added and the cumulative open time Q1 is subtracted. For example, when the door 12 is in the closed state for t minutes, t minutes are subtracted from the cumulative open time Q1, and t minutes are added to the cumulative closed time Q2. On the other hand, when the door 12 is in the open state, the time for which the door is left open is added to the cumulative open time Q1 and is subtracted from the cumulative closed time Q2. By doing so, the fadeaway of the effect of the cumulative closed time is reflected. The effect of the cumulative closed time Q2 for which the door 12 is in the closed state fades away when the door 12 is open since the thickness of the pressed gasket 12a returns to the original thickness (becomes thicker). The fading away of the effect of the cumulative open time is reflected. The effect of the cumulative open time Q1 for which the door 12 is in the open state fades away when the door 12 is closed since the gasket 12a, of which a thickness became larger, is pressed and becomes thinner. The document reading apparatus 1a estimates the thickness of the gasket 12a based on the cumulative open time Q1 and the cumulative closed time Q2. Specifically, the cumulative open time Q1 and the cumulative closed time Q2 are compared with each other. If Q1>Q2 is satisfied, it is determined that the gasket 12a is thicker than a reference thickness (for example, a design value for the thickness of the gasket 12a). The degree of how much the gasket 12a becomes thicker than a reference thickness is defined by a difference value (Q1−Q2). On the other hand, if Q1<Q2 is satisfied, it is determined that the gasket 12a is thinner than the reference thickness (for example, the design value for the thickness of the gasket 12a). The degree of how much the gasket 12a becomes thinner is defined by a difference value (Q2−Q1). The document reading apparatus 1a controls the attracting force of the electromagnet 17 by causing a current to flow in the electromagnet 17 according to the estimated thickness of the gasket 12a.

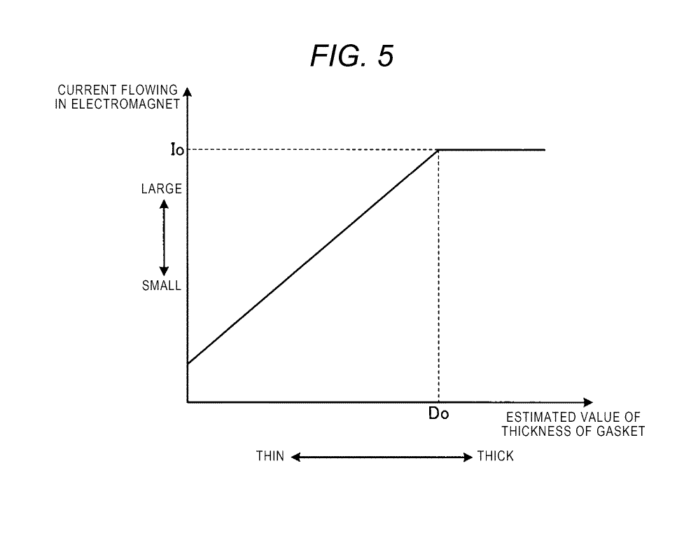

For example, as shown in FIG. 5, the current flowing in the electromagnet 17 is increased if it is estimated that the gasket 12a is thicker than the reference thickness based on the cumulative open time Q1 and the cumulative closed time Q2. On the other hand, a current flowing in the electromagnet 17 is decreased if it is estimated that the gasket 12a is thinner than the reference thickness based on the cumulative open time Q1 and the cumulative closed time Q2. FIG. 5 is a graph showing an example of a relationship between an estimated thickness of the gasket 12a and the magnitude of the current flowing in the electromagnet 17. In an example of FIG. 5, the estimated thickness of the gasket 12a is proportional to the magnitude of a current flowing in the electromagnet 17. In reality, the opening and closing load of the door 12 is also affected by the material of the gasket 12a, the weight of the door 12, and the senses of an operator. Accordingly, evaluation by a plurality of experts is performed in advance, and a relationship between the thickness of the gasket 12a and the current flowing in the electromagnet 17 is set as appropriate. In the example of FIG. 5, if the gasket 12a is estimated to be thicker than a predetermined thickness Do, the current flowing in the electromagnet 17 is limited to a predetermined current Io. That is to provide an upper limit on the magnitude of a current flowing in the electromagnet 17 in order to protect the electromagnet 17.

(Description of the Hardware Configuration of Reading Unit)

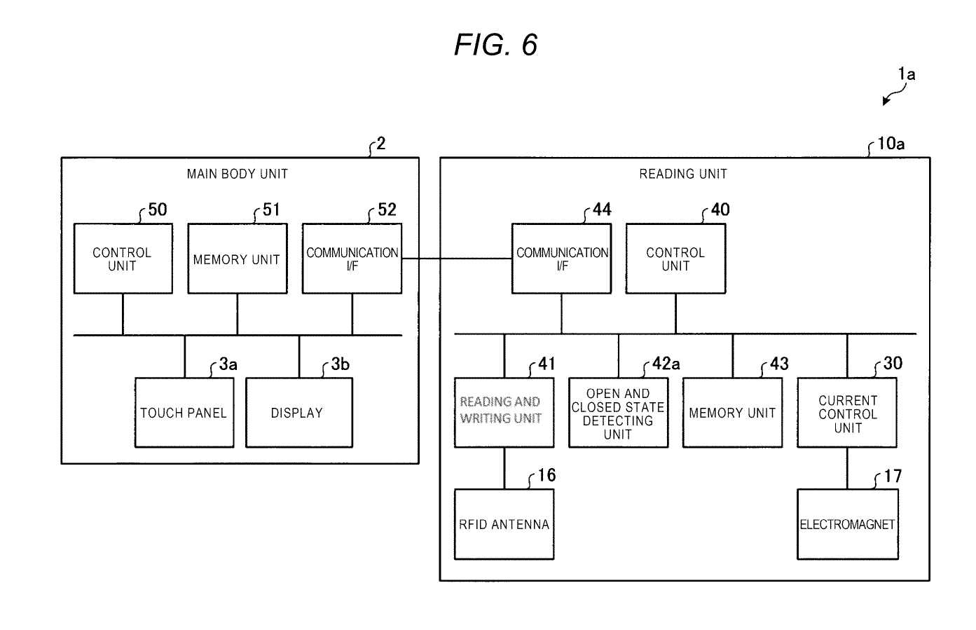

Next, the hardware configuration of the reading unit 10a will be described. FIG. 6 is a block diagram showing the hardware configurations of the main body unit 2 and the reading unit 10a.

The main body unit 2 includes a control unit 50, which is a computer configured of a central processing unit (CPU), a read only memory (ROM), and a random access memory (RAM). The ROM stores various types of programs executed by the CPU and various types of data. The RAM temporarily stores data and programs when the CPU executes various types of programs.

The touch panel 3a and the display 3b are connected to the control unit 50 via various types of input and output circuits (not illustrated).

In addition, a memory unit 51 and a communication I/F 52 are connected to the control unit 50 via various types of input and output circuits (not illustrated).

The memory unit 51 is a memory device that includes a nonvolatile storage medium such as a hard disk drive (HDD) and a solid state drive (SSD). The memory unit 51 stores various types of programs and various types of data related to operation of the main body unit 2. In addition, the memory unit 51 stores document codes read by the reading unit 10a. The memory unit 51 may store a data table of a database (hereinafter, referred to as a table) associated with document codes, in which information pieces, such as the documents D1 related to the document codes and operators who possess the documents D1, are correlated with each other. The communication I/F 52 transmits and receives various types of data to and from the reading unit 10a.

The reading unit 10a includes a control unit 40, which is a computer configured of a CPU, a ROM, and a RAM. The ROM stores various types of programs executed by the CPU and various types of data. The RAM temporarily stores data and programs when the CPU executes various types of programs.

The RFID reading and writing unit 41, an open and closed state detecting unit 42a, a memory unit 43, a current control unit 30, and a communication I/F 44 are connected to the control unit 40 via various types of input and output circuits (not illustrated). The control unit 40 calculates the cumulative open time Q1 and the cumulative closed time Q2 based on the open and closed states of the door 12 detected by the open and closed state detecting unit 42a to be described later.

The RFID reading and writing unit 41 transmits modulated waves (radio waves) for the reading and writing of the RFID tag T1 by driving the RFID antenna 16. The RFID reading and writing unit 41 outputs various types of information (for example, document codes) read from the RFID tag T1 to the control unit 40 via the RFID antenna 16. In addition, by outputting information to be written (for example, flag information) via the RFID antenna 16, the RFID reading and writing unit 41 writes the information in the RFID tag T1.

The open and closed state detecting unit 42a detects whether the door 12 is in the closed state or the door 12 is in the open state. The open and closed state detecting unit 42a is, for example, configured of the aforementioned switch 21 (refer to FIG. 3). Operation of the switch 21 is as described above. In reality, the switch 21 is turned on when the door 12 is in a state of being about to be closed, and the switch 21 is turned off when the door 12 is in a state of being about to be opened. However, in theory, the switch 21 is turned on when the door 12 is in the closed state, and the switch 21 is turned off when the door 12 is in the open state. Detection results of the open and closed state detecting unit 42a are output to the control unit 40. The memory unit 43 is a memory device including a nonvolatile storage medium such as a HDD and a SSD. The memory unit 43 stores various types of programs and various types of data related to the operation of the reading unit 10a.

The current control unit 30 controls the magnitude of a current flowing in the electromagnet 17. Specifically, the current control unit 30 is formed of an electronic circuit, in which a switching element such as a transistor is used. Attracting force corresponding to the magnitude of a current caused to flow by the current control unit 30 is generated in the electromagnet 17.

The communication I/F 44 transmits and receives various types of data to and from the main body unit 2. The control unit 40, the RFID reading and writing unit 41, the memory unit 43, the current control unit 30, and the communication I/F 44 included in the reading unit 10a are mounted on a circuit board (not illustrated), and are accommodated, for example, in a space between the placing surface 15 and the bottom surface 18 of the housing 11 illustrated in FIG. 2A.

(Description of the Functional Configuration of Reading Unit)

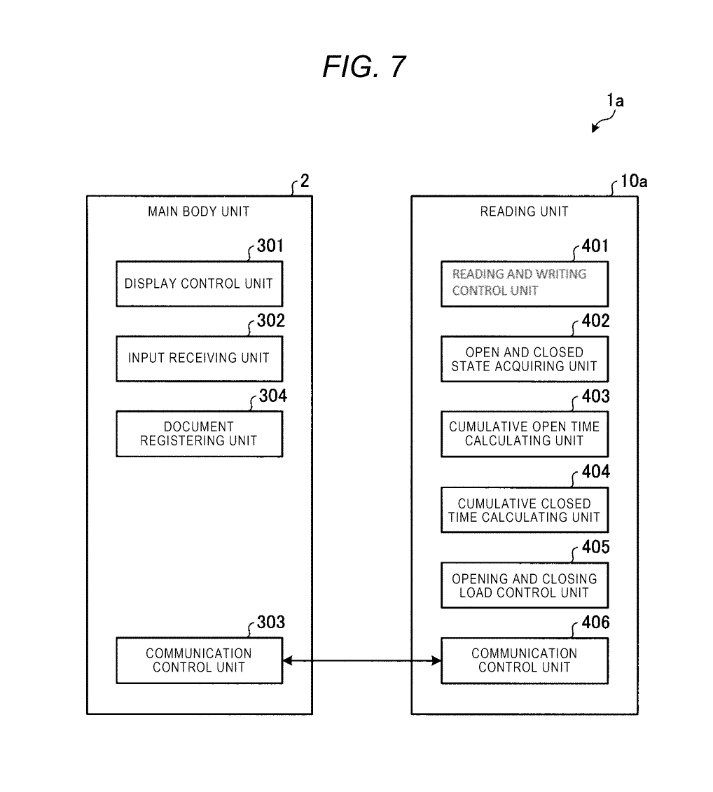

Next, the functional configuration of the document reading apparatus 1a will be described. FIG. 7 is a block diagram showing functional configurations of the main body unit 2 and the reading unit 10a.

By cooperating with a program stored in the memory unit 51, the control unit 50 (CPU) of the main body unit 2 realizes a display control unit 301, an input receiving unit 302, a communication control unit 303, and a document registering unit 304 as functional units.

The display control unit 301 controls the display 3b, and displays various types of screens onto the display 3b. For example, the display control unit 301 displays a screen including an operation button for instructing the start of reading a document code (RFID tag T1) (hereinafter, referred to as a reading start button) and an operation button for instructing the termination of the reading (hereinafter, referred to as a reading termination button). If a table is stored in the memory unit 51, the display control unit 301 may read information corresponding to a document code transmitted from the reading unit 10a from the table to display the information onto the display 3b.

The input receiving unit 302 receives an operation input via the touch panel 3a. For example, if an operation button is operated (touched) on an operation screen on the display 3b, the input receiving unit 302 outputs an instruction corresponding to the operation button to the control unit 50.

The communication control unit 303 controls the communication I/F 52 to transmit and receive various types of information to and from the reading unit 10a via the communication I/F 52. For example, if the reading start button is operated, the communication control unit 303 transmits an instruction to start reading to the reading unit 10a. The communication control unit 303 receives a document code transmitted from the reading unit 10a. If the reading termination button is operated, the communication control unit 303 transmits an instruction to terminate reading to the reading unit 10a. In addition, if document registration by the document registering unit 304 is completed, the communication control unit 303 transmits an instruction to complete registration to the reading unit 10a.

The document registering unit 304 registers a read document code by storing the document code transmitted from the reading unit 10a in a predetermined region of the memory unit 51. Specifically, the document registering unit 304 stores a document code received by the communication control unit 303 with date and time of the receipt in a storage region for registration (for example, a database). The storage region for registration may be included in an external device capable of communicating with the main body unit 2.

By cooperating with a program stored in the memory unit 43, the control unit 40 (CPU) of the reading unit 10a realizes an RFID reading and writing control unit 401, an open and closed state acquiring unit 402, a cumulative open time calculating unit 403, a cumulative closed time calculating unit 404, an opening and closing load control unit 405 (an example of a controlling unit), and a communication control unit 406 as functional units.

By controlling the RFID reading and writing unit 41, the RFID reading and writing control unit 401 reads the RFID tag T1 attached to the document D1 and writes information into the RFID tag T1. Specifically, the RFID reading and writing control unit 401 starts reading if the main body unit 2 instructs the RFID reading and writing control unit 401 to start reading and open and closed state information acquired by the open and closed state acquiring unit 402 to be described later indicates that the door 12 is in the closed state.

In addition, if the main body unit 2 instructs the RFID reading and writing control unit 401 to terminate reading, the RFID reading and writing control unit 401 terminates reading performed by the RFID reading and writing unit 41. Then, if the main body unit 2 instructs the RFID reading and writing control unit 401 to complete registration, the RFID reading and writing control unit 401 controls the RFID reading and writing unit 41 to start writing a registration completion flag. Herein, the registration completion flag indicates that document registration is completed, and is written in a predetermined storage region of the RFID tag T1.

If the door 12 comes into the open state between the start of reading of the RFID tag T1 and the writing of a registration completion flag, the RFID reading and writing control unit 401 terminates reading and resets a document code that was read so far. Due to the resetting, a document code transmitted (registered) to the main body unit 2 is reset as well. Then, if it is checked that the door 12 is in the closed state, the RFID reading and writing control unit 401 reads the RFID tag T1 again.

As a consequence, even if the documents D1, of which the RFID tag T1 is read, are taken out from the accommodating chamber 19 before writing a registration completion flag and even if the documents D1, of which the RFID tag T1 is yet to be read, is put into the accommodating chamber 19, the documents D1 in the accommodating chamber 19 can be reliably read. In a modification, the display 3b may show information that the door 12 is in the open state, and such information may be communicated to the main body unit 2.

By cooperating with the open and closed state detecting unit 42a, the open and closed state acquiring unit 402 acquires open and closed state information indicating whether the door 12 is in the open state or in the closed state and time information indicating time when the open and closed state information is acquired. Specifically, the open and closed state acquiring unit 402 determines that the door 12 is in the closed state under a condition that it is detected that the push portion 211 of the switch 21 is pressed by the projecting portion 24 of the door 12 (refer to FIG. 3). In addition, the open and closed state acquiring unit 402 determines that the door 12 is in the open state under a condition that it is detected that the projecting portion 24 of the door 12 is separated away from the push portion 211 of the switch 21.

By cooperating with the control unit 40, the cumulative open time calculating unit 403 calculates the cumulative open time Q1 for which the door 12 is in the open state based on open and closed state information of the door 12 acquired by the open and closed state acquiring unit 402 and time information indicating when the open and closed state information is acquired. Specifically, the cumulative open time calculating unit 403 calculates cumulative time for which the switch 21 illustrated in FIG. 3 is turned off (the push portion 211 of the switch 21 is not pressed). In addition, when the switch 21 is turned on, the cumulative open time calculating unit 403 subtracts cumulative time for which the switch 21 is turned on from the cumulative open time Q1.

By cooperating with the control unit 40, the cumulative closed time calculating unit 404 calculates the cumulative closed time Q2 for which the door 12 is in the closed state based on open and closed state information of the door 12 acquired by the open and closed state acquiring unit 402 and time information indicating time when the open and closed state information is acquired. Specifically, the cumulative closed time calculating unit 404 calculates cumulative time for which the switch 21 illustrated in FIG. 3 is turned on (the push portion 211 of the switch 21 is pressed). In addition, when the switch 21 is turned off, the cumulative closed time calculating unit 404 subtracts cumulative time for which the switch 21 is turned off from the cumulative closed time Q2.

The opening and closing load control unit 405 cooperates with the current control unit 30 to control the magnitude of a current flowing in the electromagnet 17 and thereby controls the opening and closing load (force) when opening and closing the door 12. Specifically, the opening and closing load control unit 405 determines the magnitude of the current flowing in the electromagnet 17 based on the cumulative open time Q1 of the door 12 calculated by the cumulative open time calculating unit 403 and the cumulative closed time Q2 of the door 12 calculated by the cumulative closed time calculating unit 404. The opening and closing load control unit 405 causes a current having the determined magnitude to flow in the electromagnet 17 by controlling the current control unit 30. Timing at which a current starts flowing may be, for example, a moment when the switch 21 configuring the open and closed state detecting unit 42a is turned on from being turned off. In addition, timing at which a current stops flowing may be, for example, a moment when the switch 21 configuring the open and closed state detecting unit 42a is turned off from being turned on.

The communication control unit 406 controls the communication I/F 44 and transmits and receives various types of information to and from the main body unit 2 via the communication I/F 44. For example, the communication control unit 406 receives an instruction to start reading transmitted thereto from the main body unit 2. The communication control unit 406 transmits a document code read from the RFID tag T1 by the RFID reading and writing control unit 401 to the main body unit 2. The communication control unit 406 receives an instruction to terminate reading transmitted thereto from the main body unit 2. In addition, the communication control unit 406 receives an instruction to complete registration transmitted thereto from the main body unit 2.

(Description on Flow of Processing Performed by Reading Unit)

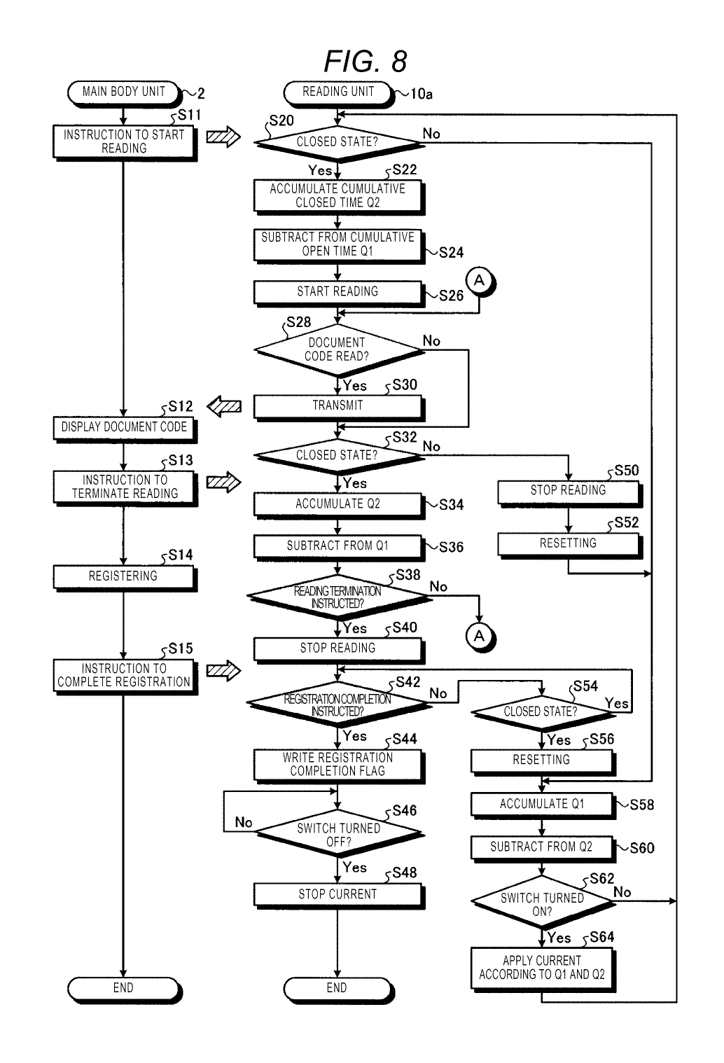

Next, operation of the document reading apparatus 1a will be described. FIG. 8 is a flow chart showing an operation example of the main body unit 2 and the reading unit 10a. A operator opens the door 12 of the reading unit 10a and accommodates the documents D1 in the accommodating chamber 19. Next, the operator starts processing by operating the reading start button displayed on the display 3b of the main body unit 2.

When the input receiving unit 302 in the main body unit receives an input from the reading start button, the communication control unit 303 transmits an instruction to start reading to the reading unit 10a (S11).

When the communication control unit 406 in the reading unit 10a receives the instruction to start reading, the RFID reading and writing control unit 401 determines whether the door 12 is in the closed state based on open and closed state information acquired by the open and closed state acquiring unit 402 (S20). When the RFID reading and writing control unit 401 determines that the door 12 is in the open state (S20; No), processing proceeds to S58.

Next, the cumulative open time calculating unit 403 accumulates the time for which the door 12 is open as the cumulative open time Q1 (S58). After that, the cumulative closed time calculating unit 404 subtracts the time for which the door 12 is open from the cumulative closed time Q2 (S60). Then, the open and closed state acquiring unit 402 determines whether the switch 21 is turned on, that is, whether the door 12 is closed (S62). If the switch 21 is turned on (S62; Yes), that is, if the door 12 is closed, processing proceeds to S64. On the other hand, if the switch 21 is turned off (S62; No), that is, if the door 12 is open, processing returns to S20.

Subsequently, in S64, the opening and closing load control unit 405 cooperates with the current control unit 30 to apply a current based on the thickness of the gasket 12a, which is estimated from the cumulative open time Q1 and the cumulative closed time Q2, to the electromagnet 17. After this, processing returns to S20.

On the other hand, if it is determined that the door 12 is in the closed state in S20 (S20; Yes), the cumulative closed time calculating unit 404 accumulates the time for which the door 12 is closed as the cumulative closed time Q2 (S22). Then, the cumulative open time calculating unit 403 subtracts the time for which the door 12 is closed from the cumulative open time Q1 (S24).

Next, the RFID reading and writing control unit 401 starts reading the RFID tag T1 (S26). At this time, the RFID antenna 16 starts emitting radio waves. Next, the RFID reading and writing unit 41 determines whether a document code is read from the RFID tag T1 (S28). If the document code is not read (S28; No), processing proceeds to S32.

On the other hand, if the document code is read in S28 (S28; Yes), the communication control unit 406 subsequently transmits the document code to the main body unit 2 (S30). After then, processing proceeds to S32.

In S32, the RFID reading and writing control unit 401 determines whether the door 12 is in the closed state based on open and closed state information acquired by the open and closed state acquiring unit 402. If it is determined that the door 12 is the open state (S32; No), the RFID reading and writing control unit 401 stops reading the RFID tag T1 (S50). At this time, the RFID antenna 16 stops emitting radio waves. Then, the RFID reading and writing control unit 401 resets the document code which was read so far (S52). After this, processing proceeds to S58. Due to such resetting, document codes transmitted and registered in the main body unit 2 can be reset as well.

In addition, if it is determined that the door 12 is in the closed state in S32 (S32; Yes), the cumulative closed time calculating unit 404 accumulates the time for which the door 12 is closed as the cumulative closed time Q2 (S34). Then, the cumulative open time calculating unit 403 subtracts the time for which the door 12 is closed from the cumulative open time Q1 (S36). Next, the RFID reading and writing control unit 401 determines whether the termination of reading has been instructed by the main body unit 2 (S38). If there is no instruction to terminate reading (S38; No), processing proceeds to S28.

If the reading of the RFID tag T1 starts in a state where the accommodating chamber 19 is in an empty state, a loop, in which S28; No, S32; Yes, S34, S36, and S38; No subsequently follows, continues without a single RFID tag T1 being read. In order to avoid such a loop, the reading of the RFID tag T1 may be forcibly terminated if a predetermined length of time (for example, five seconds) passes or the loop is executed a predetermined number of times without a single RFID tag T1 being read. In this case, it is preferable that the RFID reading and writing control unit 401 cooperate with the display control unit 301 of the main body unit 2 and display a message that the RFID tag T1 cannot be read.

When the communication control unit 303 of the main body unit 2 receives a document code from the reading unit 10a, the display control unit 301 displays the document code onto the display 3b (S12).

When it is checked that document codes of all the documents D1 accommodated in the accommodating chamber 19 are displayed by referring to the document codes displayed on the display 3b, an operator operates the reading termination button displayed on the display 3b. Then, when the input receiving unit 302 receives an input from the reading termination button, the communication control unit 303 transmits an instruction to terminate reading to the reading unit 10a (S13).

The document registering unit 304 in the main body unit 2 registers each of the displayed document codes (S14). Then, the communication control unit 303 transmits an instruction to complete registration to the reading unit 10a (S15). The processing of FIG. 8 is terminated.

When the communication control unit 406 in the reading unit 10a receives the instruction to terminate reading, the RFID reading and writing control unit 401 determines whether the termination of reading is instructed (S38; Yes). Next, the RFID reading and writing control unit 401 stops the RFID antenna 16 from emitting radio waves, and stops reading the RFID tag T1 (S40).

Subsequently, the RFID reading and writing control unit 401 determines whether or not registration completion is instructed by the main body unit 2 (S42). If there is no instruction to complete registration (S42; No), the RFID reading and writing control unit 401 determines whether the door 12 is in the closed state based on open and closed state information acquired by the open and closed state acquiring unit 402 (S54).

If it is determined that the door 12 is in the closed state in S54 (S54; Yes), processing returns to S42. In addition, if it is determined that the door 12 is in the open state (S54; No), the RFID reading and writing control unit 401 resets as in S52 (S56). After then, processing proceeds to S58.

On the other hand, if the RFID reading and writing control unit 401 determines that registration completion is instructed in S42 (S42; Yes), the RFID reading and writing control unit 401 controls the RFID reading and writing unit 41 and writes a registration completion flag in the RFID tag T1 of each document D1 (S44).

Subsequently, the open and closed state acquiring unit 402 determines whether the switch 21 is turned off, that is, whether the door 12 is open (S46). If the switch 21 is turned off (S46; Yes), that is, if the door 12 is open, the opening and closing load control unit 405 cooperates with the current control unit 30 and stops the current applied to the electromagnet 17 (S48). Then, the processing of FIG. 8 is terminated. On the other hand, if the switch 21 is turned on in S46 (S46; No), that is, if the door 12 is closed, S46 is repeated.

### Second Embodiment

A document reading apparatus 1b having a reading unit 10b that includes a door opening and closing device will be described as a second embodiment. The reading unit 10b includes an open and closed state detecting unit 42b which is different from that of the first embodiment. Since a hardware configuration and a functional configuration of the document reading apparatus 1b are the same as in the document reading apparatus 1a, description thereof will be omitted and only a configuration and effects of the open and closed state detecting unit 42b will be described.

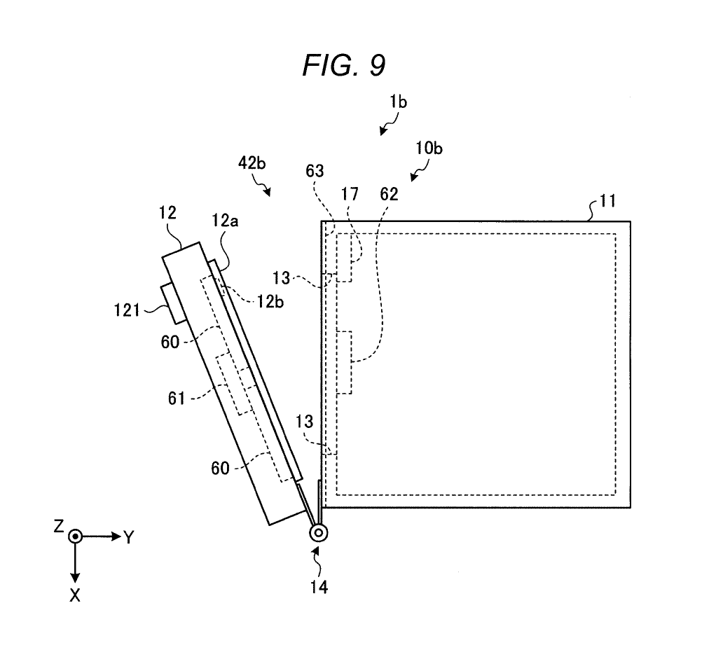

FIG. 9 is a top view of the reading unit 10b provided with the open and closed state detecting unit 42b. The open and closed state detecting unit 42b includes a configuration of a power meter which measures high-frequency power. That is, the open and closed state detecting unit 42b includes a dipole antenna 60, an antenna control unit 61, a receiving unit 62, and a metal frame 63. The open and closed state detecting unit 42b receives radio waves emitted from the dipole antenna 60 by means of the receiving unit 62, and estimates a distance between the door 12 and the perimeter wall 11a of the housing surrounding the opening 13 based on the intensity of received radio waves.

In FIG. 9, the dipole antenna 60 and the antenna control unit 61 are provided inside the door 12. A wall surface of the door 12 on the opening 13 side is configured of an insulating plate member that transmits radio waves emitted from the dipole antenna 60, such as wood and glass. The receiving unit 62 is provided in the vicinity of the opening 13 of the housing 11. The metal frame 63 is provided on an outer perimeter portion of the opening 13.

Radio waves emitted from the dipole antenna 60 pass through the opening 13 and are received by the receiving unit 62. In this state, since the metal frame 63 is provided along the outer perimeter portion of the opening 13, some of the radio waves emitted from the dipole antenna 60 are attenuated due to the effect of the metal frame 63. The amount of radio waves attenuated by the metal frame 63 increases as the door 12 and the opening 13 come to a state of being close to each other. By using this principle, the open and closed state detecting unit 42b estimates a distance between the door 12 and the perimeter wall 11a of the housing 11 surrounding the opening 13 based on the intensity of radio waves received by the receiving unit 62.

The opening and closing load control unit 405 (FIG. 7) controls the opening and closing load of the door 12 by applying a current according to the distance between the door 12 and the opening 13 estimated by the open and closed state detecting unit 42b to the electromagnet 17.

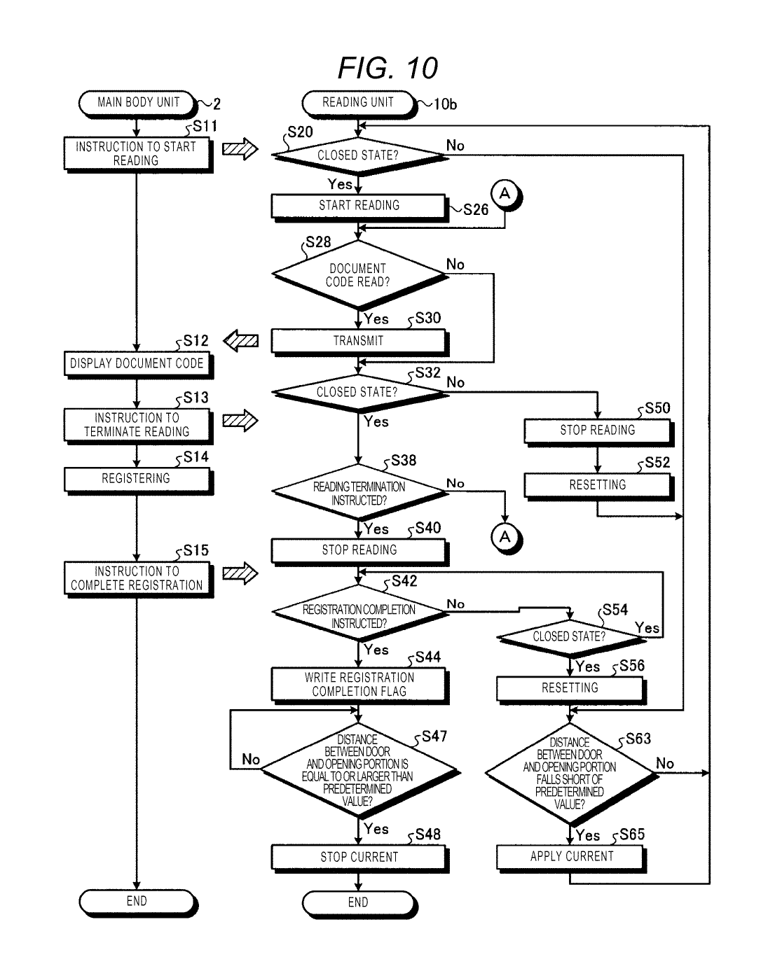

FIG. 10 is a flow chart showing the flow of processing performed by the document reading apparatus 1b (reading unit 10b and main body unit 2) which includes the open and closed state detecting unit 42b. FIG. 10 is different from the flow chart described in the first embodiment (FIG. 8) in the following points. That is, the flow chart of FIG. 10 does not include processing related to the cumulative open time Q1 and the cumulative closed time Q2 (Acts 22, 24, 34, 36, 58, and 60 described in FIG. 8).

In addition, in place of S46 in FIG. 8, processing of S47 is performed in the flow chart of FIG. 10. In the processing of S47, it is determined that whether a distance between the door 12 and the perimeter wall 11a of the housing 11 surrounding the opening 13 is equal to or larger than a threshold distance based on an output from the receiving unit 62. If the distance between the door 12 and the perimeter wall 11a of the housing surrounding the opening 13 is equal to or larger than the threshold distance (S47; Yes), the opening and closing load control unit 405 determines that the door 12 is in the open state, and cooperates with the current control unit 30 to stop a current being applied to the electromagnet 17 (S48). On the other hand, if the distance between the door 12 and the perimeter wall 11a of the housing 11 surrounding the opening 13 is less than the threshold distance (S47; No), S47 is repeated.

In the flow chart of FIG. 10, processing of S63 is performed in place of S62 in FIG. 8, and processing of S65 is performed in place of S64. In the processing of S63, it is determined that whether the distance between the door 12 and the perimeter wall 11a of the housing 11 surrounding the opening 13 is less than the threshold distance based on output from the receiving unit 62. If the distance between the door 12 and the perimeter wall 11a of the housing 11 surrounding the opening 13 is less than the threshold distance (S63; Yes), the opening and closing load control unit 405 determines that the door 12 is in the closed state, and cooperates with the current control unit 30 to apply a current having predetermined magnitude set in advance to the electromagnet 17 (S65). The magnitude of a current is set to a magnitude that allows the door 12 to be reliably pulled toward the perimeter wall 11a of the housing 11 surrounding the opening 13. On the other hand, if the distance between the door 12 and the perimeter wall 11a of the housing 11 surrounding the opening 13 is equal to or larger than the threshold distance (S63; No), processing returns to S20.

Since the flow of the rest of processing in the flow chart of FIG. 10 is the same as the flow chart of FIG. 8, description thereof will be omitted.

### Third Embodiment

A document reading apparatus 1c having a reading unit 10c that includes a door opening and closing device will be described as a third embodiment. Here, the open and closed state detecting unit 42c is different from that of the first embodiment. Since a hardware configuration and a functional configuration of the document reading apparatus 1c are the same as in the document reading apparatus 1a, description thereof will be omitted, and only a configuration and effects of the open and closed state detecting unit 42c will be described.

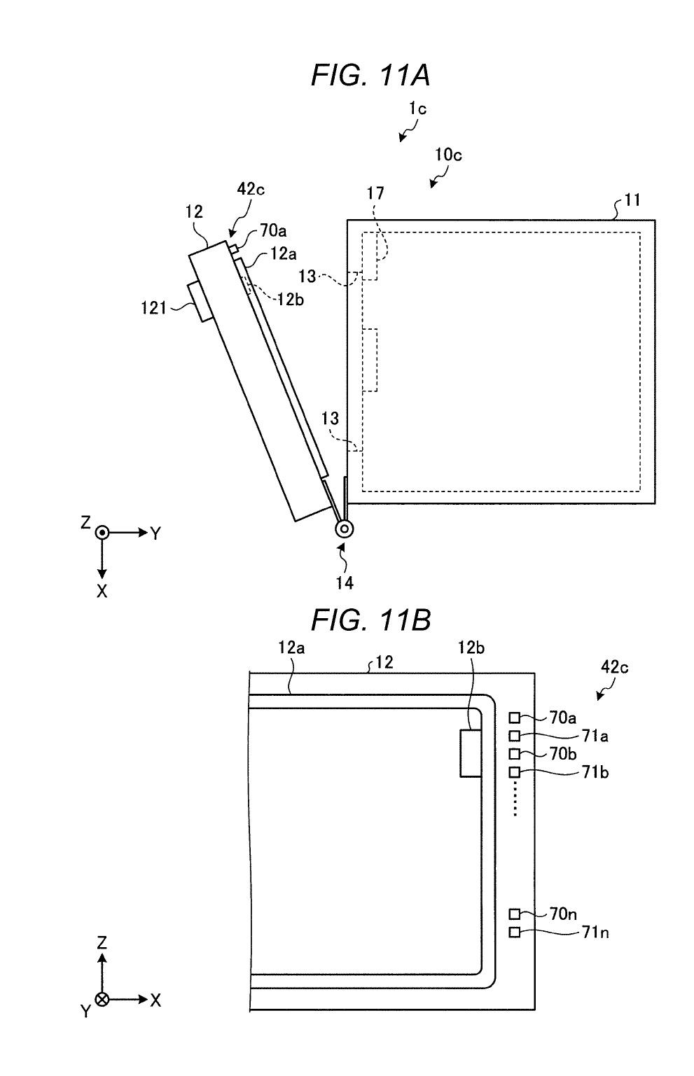

FIG. 11A is a top view of the reading unit 10c provided with the open and closed state detecting unit 42c. FIG. 11B is a rear view of the door 12. As illustrated in FIG. 11A and FIG. 11B, the open and closed state detecting unit 42c is included on a rear side edge portion of the door 12. Specifically, the open and closed state detecting unit 42c is configured of a capacitive sensor. The capacitive sensor 42c includes a plurality of electrodes 70a, 70b, . . . , and 70n, and a plurality of electrodes 71a, 71b, . . . , and 71n, which extend along the Z-axis. The plurality of electrodes 70a, 70b, . . . , and 70n and the plurality of electrodes 71a, 71b, . . . , and 71n detect a change in capacitance between the door 12 and the perimeter wall 11a of the housing 11 surrounding the (opening 13 accompanied by the opening and closing of the door 12. Capacitance decreases as a distance between the door 12 and the perimeter wall 11a of the housing 11 surrounding the housing 11 becomes smaller. That is, a distance between the door 12 and the housing 11 (opening 13) can be estimated based on the magnitude of a capacitance detected by the capacitive sensor 42c. A region of the perimeter wall 11a of the housing 11 surrounding the opening 13 opposing the electrodes 70a, 70b, . . . , and 70n, and the electrodes 71a, 71b, . . . , and 71n is formed of a dielectric substance.

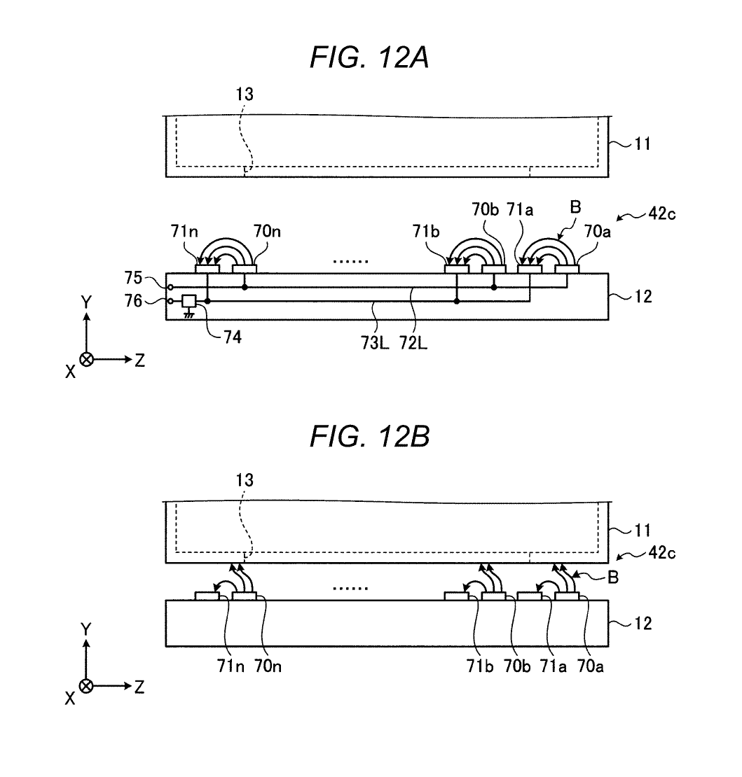

FIG. 12A illustrates an example of a state of the capacitive sensor 42c when the door 12 and the housing 11 (opening 13) are separated from each other. As illustrated in FIG. 12A, the plurality of electrodes 70a, 70b, . . . , and 70n, and the plurality of electrodes 71a, 71b, . . . , and 71n are regularly disposed at predetermined intervals from each other. All of the electrodes 70a, 70b, . . . , and 70n are connected to wiring 72L. In addition, all of the electrodes 71a, 71b, . . . , and 71n are connected to wiring 73L. A voltage having a predetermined waveform (for example, a square wave) is applied from an input terminal 75 to the wiring 72L. The wiring 73L is connected to a capacitance detection circuit 74 to be described later.

In FIG. 12A, two adjacent electrodes, for example, the electrode 70a and the electrode 71a form a capacitor. When a positive voltage is applied to the electrodes 70a, 70b, . . . , and 70n, electric lines of force B (electric field) is generated from the electrodes 70a, 70b, . . . , and 70n toward the electrodes 71a, 71b, . . . , and 71n. The amount of the electric lines of force B (number of lines) corresponds to the capacity of capacitors forming the open and closed state detecting unit 42c. If the distance between the door 12 and the housing 11 is long as illustrated in FIG. 12A, the electric lines of force B are not affected by the housing 11. Thus, the capacitance of the capacitors maintains a predetermined constant value corresponding to a voltage applied to the electrodes 70a, 70b, . . . , and 70n.

FIG. 12B illustrates an example of a state of the capacitive sensor 42c when the door 12 and the perimeter wall of 11a the housing 11 surrounding the (opening 13) are close to each other. When the distance between the door 12 and the perimeter wall 11a of the housing 11 becomes smaller, some of the electric lines of force B are pulled toward the housing 11 (opening 13) as illustrated in FIG. 12B. That is because polarization occurs at the opening 13 subjected to electrostatic induction and the electric lines of force B are pulled since regions of the opening 13 where the electrodes 70a, 70b, . . . , and 70n and the electrodes 71a, 71b, . . . , and 71n oppose each other are formed of a dielectric substance. Since the amount of the electric lines of force B from the electrodes 70a, 70b, . . . , and 70n toward the electrodes 71a, 71b, . . . , and 71n reduces due to such a change in the direction of the electric lines of force B, the capacitance of capacitors reduces. Then, since the amount of the electric lines of force B from the electrodes 70a, 70b, . . . , and 70n toward the electrodes 71a, 71b, . . . , and 71n further reduces as the distance between the door 12 and the housing 11 becomes smaller, the capacitance of the capacitors reduces accordingly.

When it is detected that the capacitance is less than a threshold voltage, the capacitance detection circuit 74 illustrated in FIG. 12A outputs a first detection signal indicating that the capacitance is less than the threshold voltage to an output terminal 76. In addition, when it is detected that the capacitance is equal to or larger than the threshold voltage, the capacitance detection circuit 74 outputs a second detection signal indicating that the capacitance is equal to or larger than the threshold voltage to the output terminal 76. Although not illustrated, a wire harness is connected to the input terminal 75 and the output terminal 76. The wire harness is connected to a controller (not illustrated) of the capacitive sensor 42c provided in a space between the placing surface 15 and the bottom surface 18 of the housing 11 illustrated in FIG. 2A via wiring routes (not illustrated) formed inside the hinge portions 14 (FIG. 4B).

The opening and closing load control unit 405 (FIG. 7) controls the opening and closing load of the door 12 by determining that a distance between the door 12 and the perimeter wall 11a of the housing 11 surrounding the opening (housing 11) is less than a threshold voltage under a condition that the first detection signal is output to the output terminal 76 by the capacitive sensor 42c and applying a current having predetermined magnitude to the electromagnet 17. In addition, the opening and closing load control unit 405 determines that a distance between the door 12 and the perimeter wall 11a of the housing 11 surrounding the opening 13 is equal to or larger than the threshold voltage under a condition that the second detection signal is output to the output terminal 76 by the open and closed state detecting unit 42c, and stops a current applied to the electromagnet 17.

Since the flow of processing performed by the document reading apparatus 1c provided with the capacitive sensor 42c (open and closed state detecting unit) is the same as in the aforementioned flowchart of FIG. 10, description thereof will be omitted.

### Fourth Embodiment

A document reading apparatus 1d having a reading unit 10d that includes a door opening and closing device will be described as a fourth embodiment. Here, the open and closed state detecting unit 42d is different from that of the first embodiment. Since the hardware configuration and a functional configuration of the document reading apparatus 1d are the same as in the document reading apparatus 1a, description thereof will be omitted, and only a configuration and effects of the open and closed state detecting unit 42d will be described.

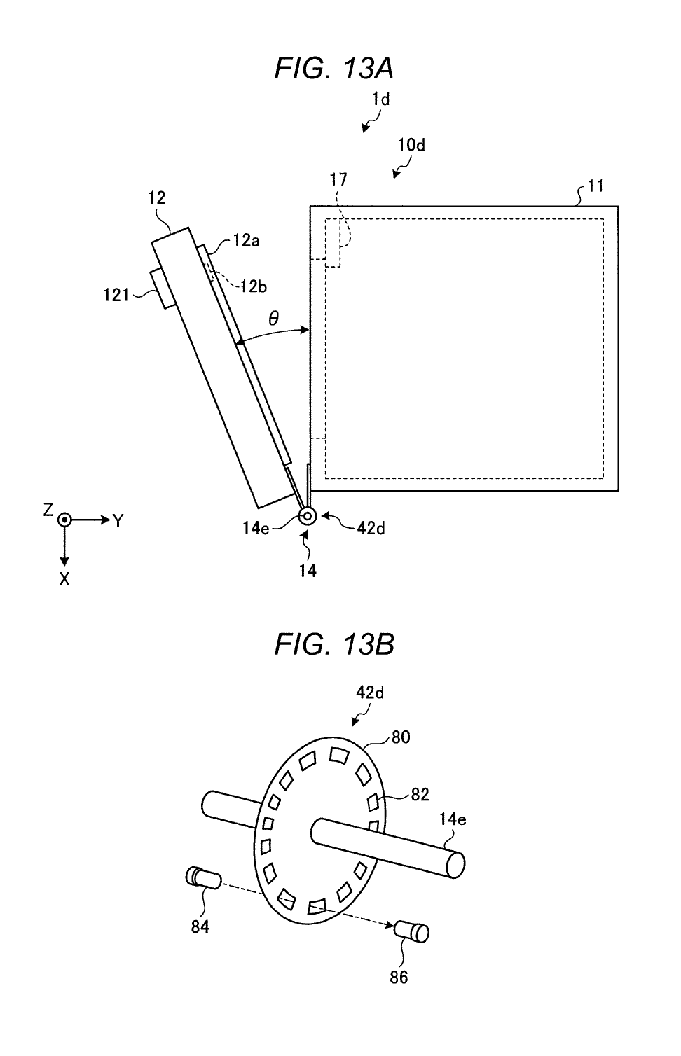

FIG. 13A is a top view of the reading unit 10d provided with the open and closed state detecting units 42d. FIG. 13B illustrates a measuring principle for the open and closed state detecting unit 42d. As illustrated in FIG. 13A, the open and closed state detecting unit 42d is provided in the hinge portions 14. More specifically, the open and closed state detecting unit 42d is a rotation angle sensor measuring rotation angles θ of the shaft portion 14e. That is, the open and closed state detecting unit 42d measures and outputs the rotation angle θ corresponding to the open and closed state of the door 12.

Next, a measuring principle for rotation angle sensor 42d will be briefly described with reference to FIG. 13B. The rotation angle sensor 42d includes a rotation plate 80, a light emitting element 84, and a light receiving element 86. The rotation plate 80 is orthogonal to the shaft portion 14e, and rotates with the shaft portion 14e. Slits 82 are formed in a regular pattern in an outer circumferential portion of the rotation plate 80. The light emitting element 84 is, for example, an LED. The light emitting element 84 is turned on at all times while measuring the rotation angle θ. The light receiving element 86 is, for example, a photodiode, and is provided at a position opposing the light emitting element 84 with the rotation plate 80 being interposed therebetween. The light receiving element 86 outputs a predetermined voltage when light output by the light emitting element 84 passes through the slits 82 and arrives in the light receiving element 86. That is, the light receiving element 86 outputs a certain pulse train according to the rotation angle θ of the shaft portion 14e when the shaft portion 14e rotates. By observing the pulse train, the rotation degree of the shaft portion 14e can be calculated.

In reality, the encoded slits 82 are formed in the rotation plate 80, and the rotation angle sensor 42d calculates the rotation direction of the shaft portion 14e and the absolute rotation angle θ.

The opening and closing load control unit 405 (FIG. 7) controls the opening and closing load of the door 12 by applying a current having predetermined magnitude to the electromagnet 17 based on the rotation direction and rotation angle θ of the shaft portion 14e, which are output by the rotation angle sensors 42d when a distance between the door 12 and the perimeter wall 11a of the housing 11 surrounding the opening 13 (housing 11) is less than a threshold distance. In addition, the opening and closing load control unit 405 stops the current applied to the electromagnet 17 based on the rotation direction and rotation angle θ of the shaft portion 14e, which are output by the rotation angle sensor 42d when a distance between the door 12 and the perimeter wall 11a of the housing 11 surrounding the opening 13 (housing 11) is equal to or larger than the threshold distance.

Since the flow of processing performed by the document reading apparatus 1d provided with the rotation angle sensor 42d (open and closed state detecting unit) is the same as in the aforementioned flow chart of FIG. 10, description thereof will be omitted.

As described above, in the document reading apparatus 1a of the first embodiment, the opening and closing load control unit 405 (controlling unit) controls an opening and closing load of the door 12 based on a distance between the opening 13 forming the interior of the housing 11 and the door 12 (door portion) provided so as to be openable and closable with respect to the opening 13. Accordingly, an opening and closing load when opening and closing the door 12 can be kept constant by adjusting the opening and closing load of the door 12, regardless of a change in the thickness of the gasket 12a (elastic member), which is provided on the perimeter of the door 12 or the perimeter of the opening 13 and seals the opening 13 and the door 12 without a gap when the door 12 is closed.

In addition, in the document reading apparatus 1a of the first embodiment, the opening and closing load control unit 405 (controlling unit) changes the force of attracting the door 12 by changing the magnitude of a current flowing in the electromagnet 17, which is in the vicinity of the opening 13 and is provided at a position opposing the plate 12b (metal body) provided on the door 12 according to a distance between the door 12 (door portion) and the opening 13, and controls an opening and closing load. Accordingly, an opening and closing load of the door 12 can be reliably and easily controlled.

In the document reading apparatus 1a of the first embodiment, the opening and closing load control unit 405 (controlling unit) estimates the distance between the door 12 and the perimeter wall 11a of the housing 11 surrounding the opening 13 by estimating the thickness of the gasket 12a (elastic member) based on the cumulative open time Q1 for which the door 12 is left in the open state and the cumulative closed time Q2 for which the door 12 is left in the closed state. Accordingly, an opening and closing load of the door 12 can be controlled so as to be constant even if the thickness of the gasket 12a changes due to aging.

In the document reading apparatus 1b of the second embodiment, the opening and closing load control unit 405 (controlling unit) estimates a distance between the door 12 and the perimeter wall 11a of the housing 11 surrounding the opening 13 based on the amount of attenuated power transmitted between the door 12 and the opening 13. Accordingly, a distance between the door 12 and the perimeter wall 11a of the housing 11 surrounding the opening 13 can be reliably and easily estimated.

In the document reading apparatus 1c of the third embodiment, the opening and closing load control unit 405 (controlling unit) estimates a distance between the door 12 and the perimeter wall 11a of the housing 11 surrounding the opening 13 based on a change in capacitance between the door 12 and the perimeter wall 11a of the housing 11 surrounding the opening 13. Accordingly, a distance between the door 12 and the opening 13 can be reliably and easily estimated.

In embodiments hereof, an open and closed state detecting unit 42a, 42b, 42c and 42d is a proximity establishing device which is used to determine the proximity of the door 12 to the opening 13 in the housing 11 or to the area of the housing 11 surrounding the opening 13. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, an opening and closing load of the door 12 may be controlled by combining the thickness of the gasket 12a estimated based on the cumulative open time Q1 and the cumulative closed time Q2, which is described in the first embodiment, with a distance between the door 12 and the housing 11 detected by the open and closed state detecting unit 42b, 42c, or 42d, which is described from the second embodiment to the fourth embodiment. That is, a distance between the door and the housing 11 when applying a current to the electromagnet 17 and when stopping a current flowing in the electromagnet 17 may be changed according to the estimated thickness of the gasket 12a. As a consequence, an opening and closing load of the door 12 can be controlled so as to be even more uniform according to a change in the thickness of the gasket 12a.

Although a method for estimating a distance between the door 12 and the opening 13 by using the open and closed state detecting unit 42a, 42b, 42c, or 42d is described, a method for measuring the distance is not limited to the aforementioned method. For example, a laser displacement gauge may be applied. The laser displacement gauge measures a distance between the door 12 and the perimeter wall 11a of the housing 11 surrounding the opening 13 based on the principle of triangulation by emitting laser light from, for example, the perimeter wall 11a of the housing 11 surrounding the opening 13 toward the door 12 and detecting laser light reflected from the door 12.

Although all of the aforementioned embodiments are described with examples in which the electromagnet 17 is used as an example of the opening and closing load control unit 405 (controlling unit), the opening and closing load control unit 405 is not limited to a configuration where the electromagnet 17 is used. For example, a configuration where an opening and closing load of the door 12 is controlled by providing an air suction port in the vicinity of the opening 13 and controlling air pressure at which the door 12 is pulled toward the perimeter wall 11a of the housing 11 surrounding the opening may be adopted. Additionally, in embodiments hereof, an open and closed state detecting unit 42a, 42b, 42c and 42d is explained as is a proximity establishing device which is used to determine the proximity of the door 12 to the opening 13 in the housing 11 or to the area of the housing 11 surrounding the opening 13.

What is claimed is:

1. A door opening and closing device comprising:
a door configured to be openable and closable with respect to an opening in a side of a housing, the housing including a perimeter wall surrounding the opening;
a seal member provided on a perimeter of the door or the perimeter wall and configured to seal the opening when the door is closed to sandwich the seal member between the door and the perimeter wall; and
a controller configured to adjust an attraction force between the door and the perimeter wall based on a distance between the door and the perimeter wall.

2. The device according to claim 1, further comprising:
an electromagnet installed on the housing,
wherein the door is configured to be magnetically attracted to the electromagnet, and the controller controls the magnitude of the attraction force based on the distance between the door and the perimeter wall by changing a magnitude of a current flowing in the electromagnet.

3. The device according to claim 1, further comprising a detector configured to detect open and closed states of the door.

4. The device according to claim 3, wherein
the detector includes a projection and a switch, and one of the projection and the switch is provided on either the door or a portion of the housing adjacent to the opening, and the other of the projection and the switch is provided on the other of the door or the portion of the housing adjacent to the opening.

5. The device according to claim 3, wherein
the detector includes a projection on the door, a switch on a portion of the housing adjacent to the opening, and a cover for the switch, the cover being configured to block radio waves.

6. The device according to claim 1, further comprising:
an accommodating chamber within the housing that is accessed through the opening; and
an antenna located externally of the accommodating chamber.

7. The device according to claim 1,
wherein the controller is configured to estimate the distance between the door and the perimeter wall by estimating a thickness of the seal member based on a cumulative open time during which the door is in an open state and a cumulative closed time during which the door is in a closed state.

8. The device according to claim 1,
wherein the controller is configured to estimate the distance between the door and the perimeter wall based on an amount of attenuation in power transmitted between the door and the perimeter wall.

9. The device according to claim 1,
wherein the controller is configured to estimate the distance between the door and the perimeter wall based on a change in a capacitance between the door and the perimeter wall.

10. The device according to claim 1,
wherein the controller is configured to estimate the distance between the door and the perimeter wall based on a change in an angle between the door and the perimeter wall.

11. A door closing assist device for closing a door over an opening in a housing, comprising:
a proximity establishing device; and
an electromagnet by which a force that assists with closing the door is generated, wherein a current of the electromagnet is changed based on a value determined by the proximity establishing device to adjust a magnitude of the force.

12. The device according to claim 11, further comprising:
a controller configured to adjust the current based on a distance between the door and the housing as determined by the proximity establishing device.

13. The device according to claim 11, further comprising a detector configured to detect the open and closed states of the door.

14. The device according to claim 13,
the detector includes a projection and a switch, and one of the projection and the switch is provided on either the door or a portion of the housing adjacent to the opening, and the other of the projection and the switch is provided on the other of the door or the portion of the housing adjacent to the opening.

15. The device according to claim 13, wherein
the detector includes a projection on the door, a switch on a portion of the housing adjacent to the opening, and a cover for the switch, the cover being configured to block radio waves.

16. The device according to claim 15, further comprising:
a seal member,
wherein the proximity establishing device is configured to estimate a distance between the door and the perimeter wall when the seal member is in contact with both the door and the housing.

17. The device according to claim 16,
wherein the proximity establishing device is configured to estimate the distance between the door and the housing by estimating a thickness of the seal member based on a cumulative open time for which the door is in an open state and a cumulative closed time for which the door is in a closed state.

18. The device according to claim 16,
wherein the proximity establishing device is configured to estimate the distance between the door and the housing based on an amount of attenuation in power transmitted between the door and the housing.

19. The device according to claim 16,
wherein the proximity establishing device is configured to estimate the distance between the door and the housing based on a change in a capacitance between the door and the housing.

20. The device according to claim 16,
wherein the proximity establishing device is configured to estimate the distance between the door and the housing based on a change in an angle between the door and the housing.
